(19) United States
(12) Patent Application Publication
(10) Pub. No.: US 2024/0270006 A1
(43) Pub. Date: Aug. 15, 2024

(54) Strategic Alignment Marker Grouped Stamps

(71) Applicant: Effie Cho, Maspeth, NY (US)

(72) Inventor: Effie Cho, Maspeth, NY (US)

(21) Appl. No.: 18/641,393

(22) Filed: Apr. 21, 2024

Related U.S. Application Data
(63) Continuation-in-part of application No. 16/841,563, filed on Apr. 6, 2020, now abandoned.

(51) Int. Cl. B41M 1/18; B41K 3/54; B41K 3/68; B41M 3/00; B42D 15/02; B44D 2/00

(52) U.S. Cl. CPC B41M 1/18; B41K 3/54; B41K 3/68; B41M 3/005; B41M 3/008; B44D 2/002; B42D 15/02

(57) ABSTRACT

The invention comprises an assortment of group stamp plates. The group stamp plates contain numerous stamps to overlay ink in subsequent layering to produce thematically related images, such as rose and its foliage. The group stamp plate also contain numerous alignment markers to assist the artisan to properly position subsequent group stamp plates to precisely layer additional layers of ink.

### CROSS REFERENCE TO RELATED APPLICATION

This application claims the benefit of U.S. patent application Ser. No. 16/841,563 titled “STRATEGIC ALIGNMENT MARKER GROUP STAMPED” filed by the applicant on Apr. 6, 2020, which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF INVENTION

The present invention generally relates to stamping, whereby an artisan creates a unique design by combining overlaying layers of stamps. The present invention comprises an entire new category of stamping by utilizing group stamping and strategically placed markers to facilitate overlaying stamp alignment. Such markers include bars, circles, and triangles at corresponding points in a series of related stamps. This increases stamp overlay consistency.

### DESCRIPTION OF THE RELATED ART

Stamping is commonly employed by artisans in the creation of personalized greeting cards, papercraft, and scrapbooking. These can be employed for birthdays, anniversaries, holidays, or any other occasion that the artisan wishes to mark with a personalized greeting card.

Stamping allows the artisan to create designs such as flowers or Christmas decorations. The design uses a series of stamps with different color ink pressed onto a paper. The design is extricated from the paper with a specialized die. The artisan can then insert and secure the extracted design onto a greeting card. With this method, the artisan can create unique and homemade cards.

The artisan can select from the various stamp and ink color to personalize any design.

Artisan stamping utilizes three different kinds of stamps. The first version is a stamp mounted on a traditional wooden block. These stamps are bulky and the wooden block obscures the artisan's sight over the paper, thus hindering stamp layering.

The second version is a clear mount on a rubber stamp combined with easy foam. These are less bulky than the wooden stamp, but the rubber's opacity makes it difficult to stamp in a precise spot and hence, also hinders stamp layering.

The third method employs photopolymer plastics. They are very thin, easily stored, and their translucency enables the artisan to correctly position a stamp over a prior image, hence allows stamp layering.

Both clear mounts and photopolymer stamps must be mounted on acrylic blocks.

A stamp positioner (i.e., misti stamping tool) is a tool which combines a stamp press, grid, and acrylic block to create a consistent stamping output. The stamp (ideally, a photopolymer), is mounted on the door of a misti stamping tool. Ink is placed on the stamp. A paper is placed on the grid opposite of the stamping door. The artisan closes the door of stamping tool, pressing the ink on the paper.

The artisan can then remove the paper, add in a clean sheet, position it in the exact same spot with the help of the gridlines, and put the same stamp design and color on this new piece of paper. Thereby, the artisan can create similar stamped paper.

Stamp layering is a common technique whereby a series of layers (usually 3-4) of ink with different stamps are placed atop one another at precise points.

By way of example, an artisan desiring to make a cut-out rose would do the following with a commercially available rose stamp kit.

First, mount the broadest rose petal stamp (i.e., first level) on the stamp layering press with properly positioned paper on the adjacent grid. Apply a light pink-colored ink, such as the ballet slippers dye ink (available from THE TON COUTURE COLOR INKS™). Press the ink-covered stamp on the adjacent paper. This creates the bottom layer of ink and broad outline of rose petals in the same color of pink. Leave the paper in place for the second step.

Second, remove the first layer rose petal stamp from the press. Position a second layer rose petal stamp in the proper position on the stamp press door. Add the desired ink to the second layer rose petal stamp, such as the Hollywood Star Dye Ink (also available from THE TON COUTURE COLOR INKS™). Press the ink-covered second layer rose petal stamp onto the paper to overlay the ink onto the paper. Leave the paper in place for the third step.

Third, remove the second layer rose petal stamp from the press. Position a third layer rose petal stamp in the proper position on the stamp press door. Add the desired ink to the third layer rose petal stamp, such as the cosmopolitan pink hybrid (also available from THE TON COUTURE COLOR INKS™). Press the ink-covered third layer rose petal stamp onto the paper to overlay the ink onto the paper. Leave the paper in place for the fourth step.

Fourth, remove the third layer stamp from the press. Position a fourth layer rose petal stamp (i.e., a floral insert) in the proper position on the stamp press door. Add the desired ink to the fourth layer rose petal stamp, such as the Beach Color Dye Ink, (also available from THE TON COUTURE COLOR INKS™). Press the ink-covered fourth layer rose petal stamp onto the paper to overlay the ink onto the paper.

A similar method can be used for the leaves of the rose flower. A suggested color scheme could be bright emerald dye ink, hot tourmaline dye ink, and ocean teal dye ink for the first, second, and third layers of ink, respectively. Each of these colors are also available from THE TON COUTURE COLOR INKS™).

This layering of stamp ink creates texture and contrast in the images. If the stamp presses are positioned correctly, it gives the appearance a three-dimensional flower.

An artisan can create a wide variety of colored flowers, including peony, amethyst, citrine, coral, or ruby, using the exact same acrylic molds, but with different assortments of ink.

A die cutting tool, such as GEMINI™ by CRAFTER'S COMPANION™ can separate the image from the same paper.

An artisan can even use a partial die cut to make a cut within an inked image. For instance, a partial cut around a flower petal creates a flap, which allows a single flower petal to rise above the others. This accentuates the three dimensional effect of the overall floral design.

Crucial to this entire process is the proper placement of the subsequent stamps on the stamp press. If any stamp in the same series is improperly positioned, the resulting image will offset, creating a shadow. The artisan would decide to leave the shadowing or discard the paper and begin anew.

In the past, artisans relied on “landmarks” within the inked image to position the next stamp. These landmarks are reference points, such as shapes and lines, within the inked image made by the prior layers. Such reference point would be any point in the image that corresponds to subsequent stamps, for example the tip of a leaf for a floral design

While positioning the second layer stamp, the artisan visually aligns a reference point of the stamp over a corresponding point on the paper's first layer of ink. The third and fourth layers would also be aligned with this same image landmark.

All of the commercially available products leave room for alignment error. If misaligned, the pictures have shadowing. If the shadowing is too strong, the images must be discarded.

Another problem with the prior art is the time consuming nature of individual stamping. The original process of lining up and stamping these individual layering images is extremely time consuming and requires much more effort and concentration in stamping.

The current invention alleviates many of these concerns over the prior art.

### SUMMARY OF THE INVENTION

A group stamping plate series for consecutive use in a stamping press, which produces a thematically connected image.

The group stamping plate series of containing at least one alignment marker.

The group stamping plate series of where the alignment marker is a rectangle.

The group stamping plate series of where the thematically connected image is a flower.

The group stamping plate series of containing between 2-20 alignment markers.

The group stamping plate series of containing between 4-6 alignment markers.

A kit comprising
(a) at least one group stamping plate series,
(b) at least one light-tone pink ink,
(c) at least one medium-tone pink ink, and
(d) at least one dark-tone pink ink.

A product for producing a thematically connected image on a greeting card, comprising:
a group stamping plate series comprising at least two photopolymer plastic stamping plates wherein all stamping plates of said photopolymer plastic stamping plate series have at least one alignment marker common to all stamping plates of said photopolymer plastic stamping plate series;
ink applied to a first photopolymer plastic stamping plate;
said ink pressed onto a piece of paper to produce an ink pattern on said piece of paper comprising a design and at least one ink alignment marker on said piece of paper;
ink applied to a second stamping plate from said group stamping plate series;
a cutting tool; and, card stock.

The product of wherein the cutting tool is a coordinating die.

The product of wherein the cutting tool is a pair of scissors.

A kit comprising:
(a) at least one group stamping plate series wherein said group stamping plate series comprises at least two photopolymer plastic stamping plates wherein all stamping plates of said photopolymer plastic stamping plate series have at least one alignment marker common to all stamping plates of said photopolymer plastic stamping plate series;
(b) at least one light-tone pink ink;
(c) at least one medium-tone pink ink;
(d) at least one dark-tone pink ink;
(e) at least one piece of paper; and
(f) at least one cutting tool.

The product of wherein the cutting tool is a coordinating die.

The product of wherein the cutting tool is a pair of scissors.

A greeting card containing a series of thematically connected images made by the steps, comprising:
(a) A first step of applying a first ink to a first photopolymer plastic stamping plate wherein said first photopolymer plastic stamping plate has at least one common alignment marker and a first design pattern;
(b) A second step of pressing the first photopolymer plastic stamping plate onto a piece of paper so that the first ink that was applied to the first photopolymer plastic stamping plate in step one is transferred to the paper to create a first inked imprint of the common alignment marker on said paper and first inked imprint of a first design pattern;
(c) A third step of applying a second ink to a second photopolymer plastic stamping plate wherein said second photopolymer plastic stamping plate has at least one common alignment marker and a second design pattern;
(d) A fourth step of visually aligning said at least one common alignment marker on the second photopolymer plastic stamping plate with the first inked imprint of the common alignment marker on said paper;
(e) A fifth step of pressing the second photopolymer plastic stamping plate onto said paper so that the second ink that was applied to the second photopolymer plastic stamping plate in step one is transferred to the paper to create (1) a layered inked imprint of the common alignment marker wherein a second inked imprint of the common alignment marker on said paper is layered directly on top of the first inked imprint of the common alignment marker on said paper, and (2) a layered inked imprint of the design wherein a second inked imprint of the second design pattern is layered directly on top of the first inked imprint of the first design pattern;
(f) A sixth step of using a cutting tool to remove the layered inked imprint of the common alignment marker from the layered inked imprint of the design;
(g) Discarding the layered inked imprint of the common alignment marker that was removed in the sixth step; and,
(h) Affixing said layered inked imprint of the design to a card stock.

The greeting card of wherein the cutting tool is a pair of scissors.

### BRIEF DESCRIPTION OF THE DRAWINGS

FIG. 1 depicts a first level group stamp of a first floral design according to the present invention.

FIG. 2 depicts a second level group stamp of a first floral design according to the present invention.

FIG. 3 depicts a third level group stamp of a first floral design according to the present invention.

FIG. 4 depicts a fourth level group stamp of a first floral design according to the present invention.

FIG. 5 depicts a fifth level group stamp of a first floral design according to the present invention.

FIG. 6 depicts a completed first floral design according to the present invention.

FIG. 7 depicts a first level group stamp of a second floral design according to the present invention.

FIG. 8 depicts a second level group stamp of a second floral design according to the present invention.

FIG. 9 depicts a third level group stamp of a second floral design according to the present invention.

FIG. 10 depicts a fourth level group stamp of a second floral design according to the present invention.

FIG. 11 depicts a fifth level group stamp of a second floral design according to the present invention.

FIG. 12 depicts a sixth level group stamp of a second floral design according to the present invention.

FIG. 13 depicts a completed second floral design according to the present invention.

### DETAILED DESCRIPTION OF PREFERRED EMBODIMENTS

The present invention solves a number of problems of the prior art. The present invention revolutionizes the field of artisan layering stamps. It removes the guesswork of lining up each layer in subsequent stamps. Further, it saves the artisan an enormous amount of time by stamping each cluster layer all in one series.

### Group Stamping

The invention utilizes group stamping of thematically connected images to facilitate the speed that an artisan can create the desired stamps.

As used herein, the term “group stamping” refers to at least 2 stamps contained within a solid rectangular plate. The plate is then mounted on a commercially available stamp press. In a preferred embodiment, between 2-20 stamps are contained within the same rectangular stamp plate.

As used herein, the term “thematically connected images” refers to the ability of the final images to be utilized together in a cohesive image. Put another way, the individual images are individual parts of a cohesive whole.

By way of example, thematically connected images for group stamping to create a rose would include individual stamps for the flower petals and foliage patterns. In a preferred embodiment, the same group stamping plate would include the flower petals and the foliage pattern.

As used herein, the term “group stamping plate series” refers to at least 2 stamp plates that are used in a consecutive manner to apply layers of ink upon one another. In a preferred embodiment, there are between 3-6 stamp plates in a group stamping plate series.

In a preferred embodiment, the number and position of stamps within the group stamping plate series is designed to provide consecutive layers of ink to create textures and depth in the overall design pattern.

In a preferred embodiment, the first layer stamp has little detail and its placement with ink produces a solid (i.e., base) layer. In a preferred embodiment, the subsequent stamps in a group stamping plate series have more detail than their predecessor stamps in the same group stamping plate series.

In a preferred embodiment, a lightest colored ink is used on the first stamp layer and darker colored inks are used in the subsequent stamp layers.

By way of example for the creation of a 3-layer rose, the first layer is stamped in a light pink ink. The second layer stamp has more detail in it and is stamped in a mid-tone pink ink. The third layer has even more detail to it and is stamped in a dark pink ink to accentuate the proper shading of the image.

In a preferred embodiment, the stamp plate is made of a translucent substances such as a photopolymer plastic.

In a preferred embodiment, the final images of the group stamping plate series are separated from one another using a coordinating die.

### Alignment Markers

The present invention utilizes the strategic placement of alignment markers in the overall design of layering clear stamps to aid in the process of aligning each group stamping plate. This enables the creation of completed layered images. This eliminates stamping errors with individually layered stamps for clear stamp pages.

As used herein, the phrase “alignment marker” is an area in the group stamping plate series with a common portion between at least two plates in the group stamping plate series.

Such alignment markers could include such patterns as circles, squares, rectangles, triangles, and the like.

The more alignment markers, the easier it is for the artisan to properly align the stamp on the prior images. In a preferred embodiment, each stamping plate has between 2-10 alignment markers. In preferentially preferred embodiment, each stamping plate has between 4-6 alignment markers.

In a preferred embodiment, the artisan puts ink on all the stamp images of the group stamping plate as well as all of the the alignment markers.

### EXAMPLE 1

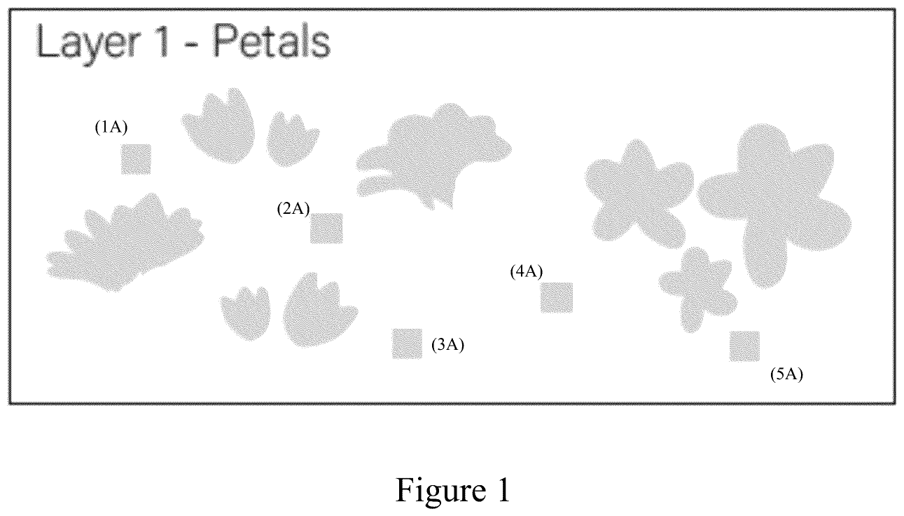

Reference is made to FIGS. 1-6.

FIG. 1 depicts the first level stamp of a group stamping plate series for a first floral design according to the present invention. Five strategically placed alignment markers are identified. These are 1A, 2A, 3A, 4A, and SA.

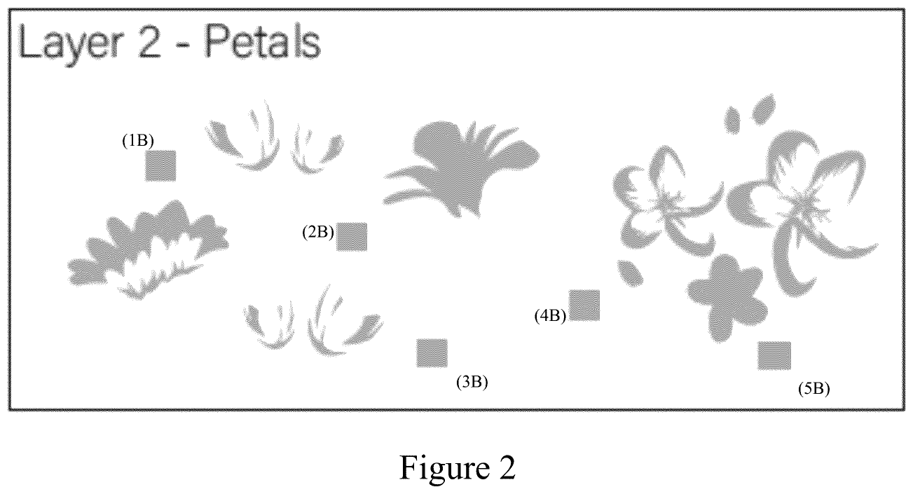

FIG. 2 depicts the second level stamp of a group stamping plate series for a first floral design according to the present invention. Five strategically placed alignment markers are identified. These are 1B, 2B, 3B, 4B, and 5B.

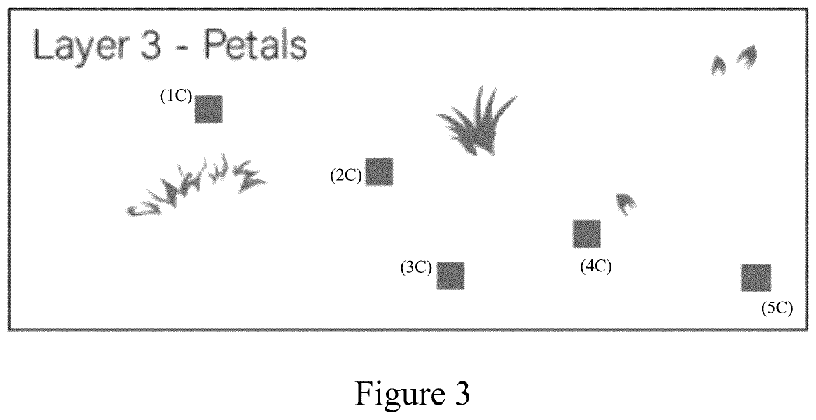

FIG. 3 depicts the third level stamp of a group stamping plate series for a first floral design according to the present invention. Five strategically placed alignment markers are identified. These are IC, 2C, 3C, 4C, and 5C.

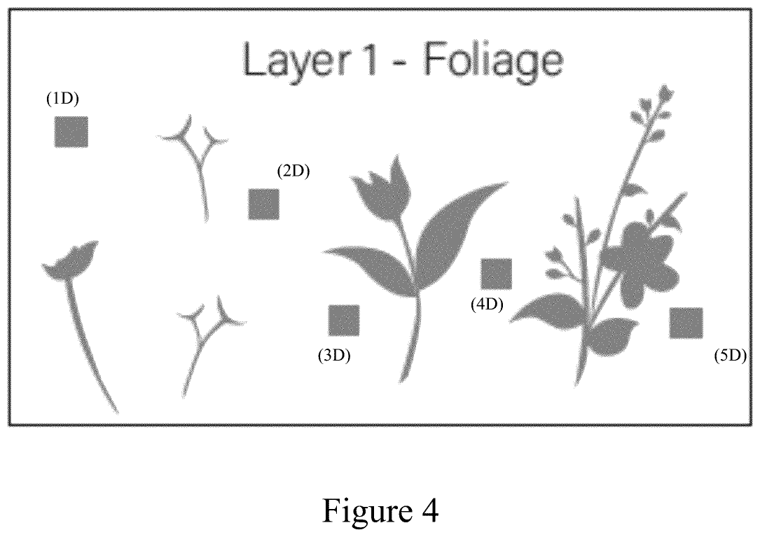

FIG. 4 depicts the fourth level stamp of a group stamping plate series for a first floral design according to the present invention. Five strategically placed alignment markers are identified. These are 1D, 2D, 3D, 4D, and 5D.

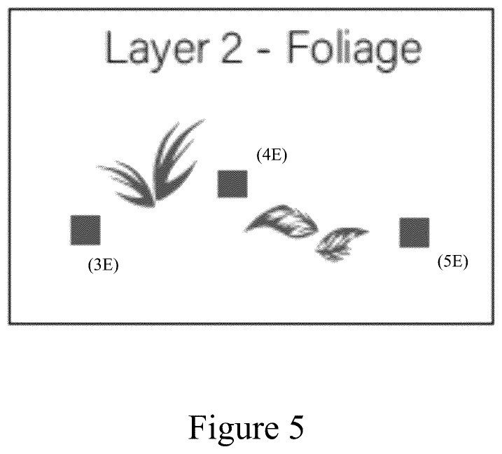

FIG. 5 depicts the fifth level stamp of a group stamping plate series for a first floral design according to the present invention. Three strategically placed alignment markers are identified. These are 3E, 4E, and 5E.

In a preferred embodiment, the various levels of the group stamping plate series are aligned with the respective alignment marker. For example, alignment markers 1A, 1B, IC, and ID are all aligned together throughout the full stamp press sequence. In likewise manner, alignment markers 2A, 2B, 2C, and 2D are all aligned together throughout the full stamp press sequence. In likewise manner, alignment markers 3A, 3B, 3C, 3D, and 3E are all aligned together throughout the full stamp press sequence. In likewise manner, alignment markers 4A, 4B, 4C, 4D, and 4E are all aligned together throughout the full stamp press sequence. In likewise manner, alignment markers 5A, 5B, 5C, 5D, and 5E are all aligned together throughout the full stamp press sequence.

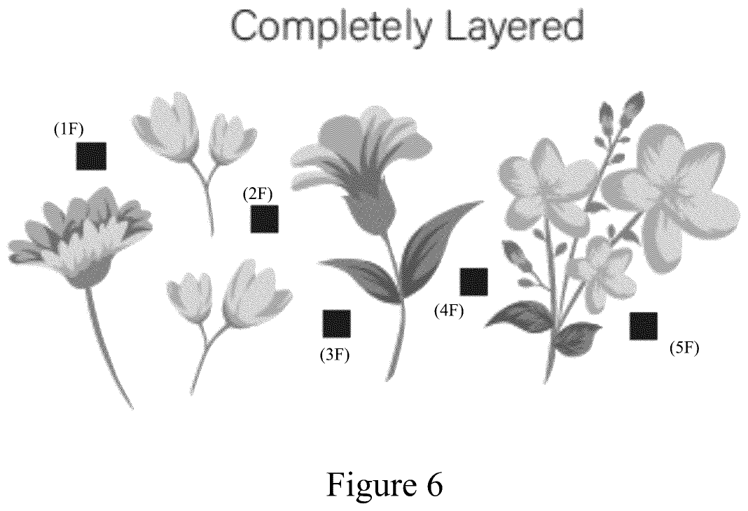

If all five alignment markers are properly positioned during the course of full pressing the entire group stamping plate series, then properly layered images are produced. This is depicted in FIG. 6, which depicts a completed first floral design according to the present invention. The images of the respective alignment markers are also visible in the fully stamped floral design. These are displayed in FIG. 6 as 1F, 2F, 3F, 4F, and 5F.

In a preferred embodiment, the completed images of FIG. 6 are cut apart with a coordinating die to separate the floral and foliage images from one another for further use by the artisan. In a preferred embodiment, the printed alignment marker images are then discarded.

This embodiment of complete set layering takes about ten minutes to stamp the entire group stamping plate series. Individually stamping similarly sized florals and leaves would take an artisan 30-40 minutes (or longer) depending on the artisan's stamping abilities and experience.

### EXAMPLE 2

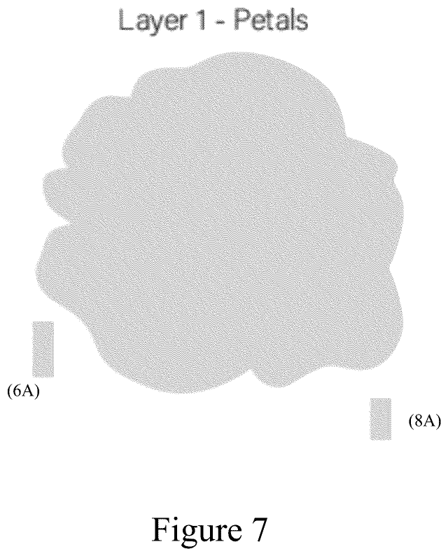

Reference is made to FIGS. 7-13.

FIG. 7 depicts the first level stamp of a group stamping plate series for a second floral design according to the present invention. Two strategically placed alignment markers are identified. These are 6A and 8A.

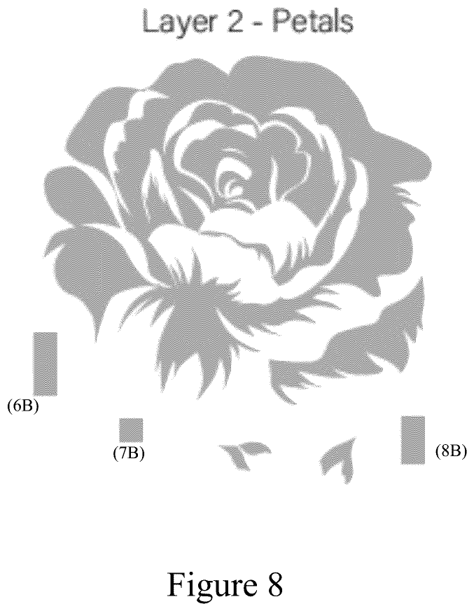

FIG. 8 depicts the second level stamp of a group stamping plate series for a second floral design according to the present invention. Three strategically placed alignment markers are identified. These are 6B, 7B, and 8B.

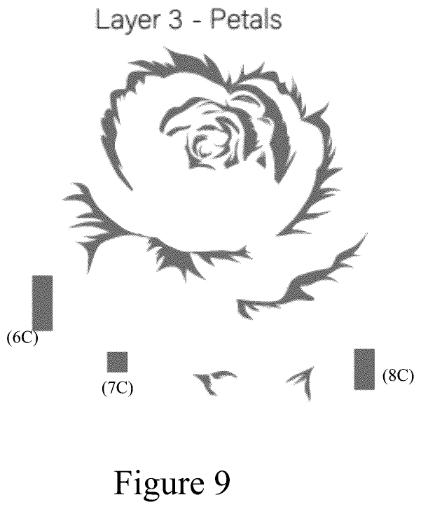

FIG. 9 depicts the third level stamp of a group stamping plate series for a second floral design according to the present invention. Three strategically placed alignment markers are identified. These are 6C, 7C, and 8C.

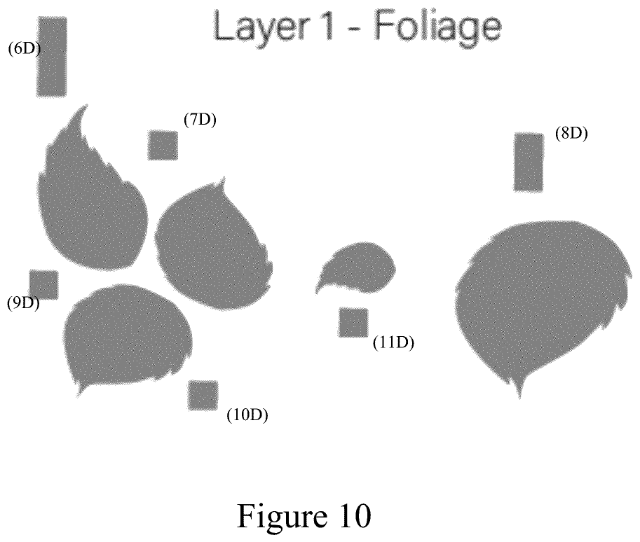

FIG. 10 depicts the fourth level stamp of a group stamping plate series for a second floral design according to the present invention. Six strategically placed alignment markers are identified. These are 6D, 7D, 8D, 9D, 10D, and 11D.

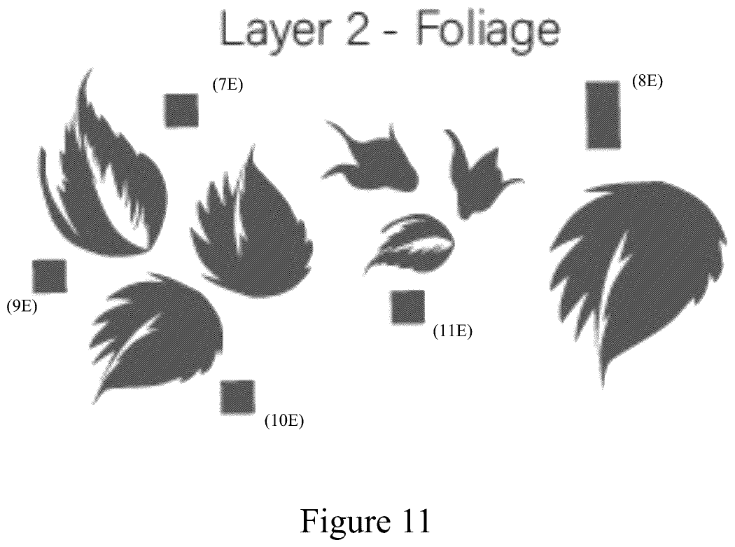

FIG. 11 depicts the fifth level stamp of a group stamping plate series for a second floral design according to the present invention. Five strategically placed alignment markers are identified. These are 7E, 8E, 9E, 10E, and 11E.

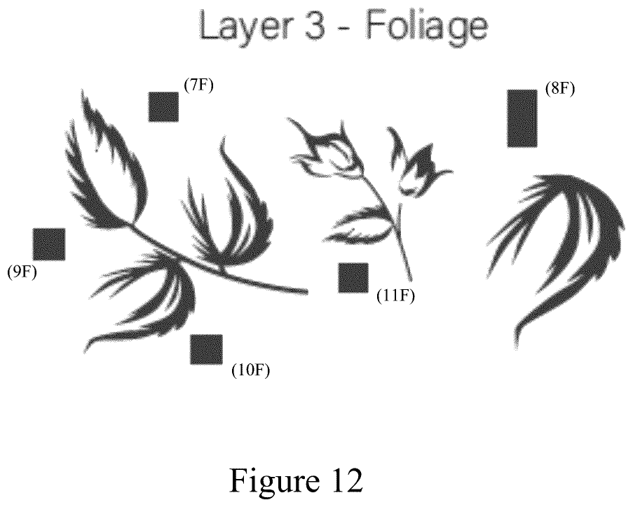

FIG. 12 depicts the sixth level stamp of a group stamping plate series for a second floral design according to the present invention. Five strategically placed alignment markers are identified. These are 7F, 8F, 9F, 10F, and 11F.

In a preferred embodiment, the various levels of the group stamping plate series are aligned with the respective alignment markers. For example, alignment markers 6A, 6B, 6C, and 6D are all aligned together throughout the entire group stamping plate series. In likewise manner, alignment markers 7B, 7C, 7D, 7E, and 7F are all aligned together throughout the entire group stamping plate series. In likewise manner, alignment markers 8A, 8B, 8C, 8D, 8E, and 8F are all aligned together throughout the entire group stamping plate series. In likewise manner, alignment markers 9D, 9E, and 9F are all aligned together throughout the entire group stamping plate series. In likewise manner, alignment markers 10D, 10E, and 10F are all aligned together throughout the entire group stamping plate series. In likewise manner, alignment markers 11D, 11E, and 11F are all aligned together throughout the entire group stamping plate series. In likewise manner, alignment markers

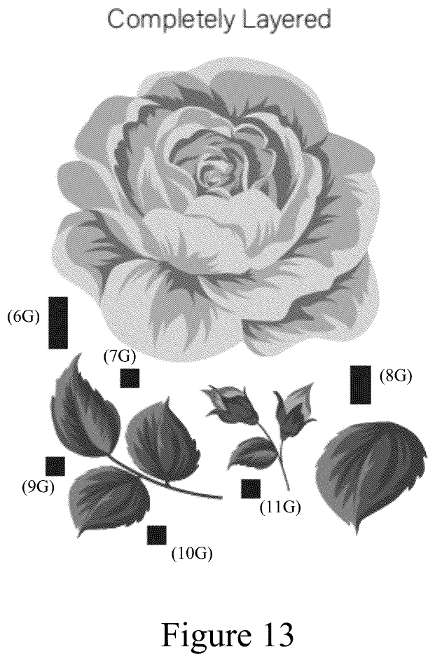

If all six alignment markers are properly positioned during the entire group stamping plate series, then properly layered images are produced. These are depicted in FIG. 13, which depicts a completed second floral design according to the present invention. The images of the respective alignment markers are also visible in the fully stamped floral design. These are displayed in FIG. 13 as 6G, 7G, 8G, 9G, 10G, and 11G.

In a preferred embodiment, the completed images of FIG. 13 are cut apart with a coordinating die to separate the floral images from one another for further use by the artisan. In a preferred embodiment, the printed alignment block images are then discarded.

### Kits

The invention also comprises a kit of the components of the strategic alignment marker grouped stamps.

The kits can be selected from the group of items described above.

The foregoing description comprises illustrative embodiments of the present invention.

As will be appreciated, the foregoing objects and examples are exemplary and embodiments need not meet all or any of the foregoing objects, and need not include all or any of the exemplary features described herein. Additional aspects and embodiments within the scope of the claims will be devised by those having skill in the art based on the teachings set forth herein.

While the invention has been described in connection with what are considered to be exemplary embodiments, it is to be understood that the invention is not limited to the disclosed embodiments, but on the contrary, is intended to cover various modifications and equivalent arrangements included within the spirit and scope of the appended claims.

I claim:

1. A product for producing a thematically connected image on a greeting card, comprising:
a group stamping plate series comprising at least two photopolymer plastic stamping plates wherein all stamping plates of said photopolymer plastic stamping plate series have at least one alignment marker common to all stamping plates of said photopolymer plastic stamping plate series;
ink applied to a first photopolymer plastic stamping plate;
said ink pressed onto a piece of paper to produce an ink pattern on said piece of paper comprising a design and at least one ink alignment marker on said piece of paper;
ink applied to a second stamping plate from said group stamping plate series;
a cutting tool; and,
card stock.

2. The product of claim 1 wherein the cutting tool is a coordinating die.

3. The product of claim 1 wherein the cutting tool is a pair of scissors.

4. A kit comprising:
(a) at least one group stamping plate series wherein said group stamping plate series comprises at least two photopolymer plastic stamping plates wherein all stamping plates of said photopolymer plastic stamping plate series have at least one alignment marker common to all stamping plates of said photopolymer plastic stamping plate series;
(b) at least one light-tone pink ink;
(c) at least one medium-tone pink ink;
(d) at least one dark-tone pink ink;
(e) at least one piece of paper; and
(f) at least one cutting tool.

5. The product of claim 4 wherein the cutting tool is a coordinating die.

6. The product of claim 5 wherein the cutting tool is a pair of scissors.

7. A greeting card containing series of thematically connected images made by steps, comprising:
(a) A first step of applying a first ink to a first photopolymer plastic stamping plate wherein said first photopolymer plastic stamping plate has at least one common alignment marker and a first design pattern;
(b) A second step of pressing the first photopolymer plastic stamping plate onto a piece of paper so that the first ink that was applied to the first photopolymer plastic stamping plate in step one is transferred to the paper to create a first inked imprint of the common alignment marker on said paper and first inked imprint of a first design pattern;
(c) A third step of applying a second ink to a second photopolymer plastic stamping plate wherein said second photopolymer plastic stamping plate has at least one common alignment marker and a second design pattern;
(d) A fourth step of visually aligning said at least one common alignment marker on the second photopolymer plastic stamping plate with the first inked imprint of the common alignment marker on said paper;
(e) A fifth step of pressing the second photopolymer plastic stamping plate onto said paper so that the second ink that was applied to the second photopolymer plastic stamping plate in step one is transferred to the paper to create (1) a layered inked imprint of the common alignment marker wherein a second inked imprint of the common alignment marker on said paper is layered directly on top of the first inked imprint of the common alignment marker on said paper, and (2) a layered inked imprint of the design wherein a second inked imprint of the second design pattern is layered directly on top of the first inked imprint of the first design pattern;
(f) A sixth step of using a cutting tool to remove the layered inked imprint of the common alignment marker from the layered inked imprint of the design;
(g) Discarding the layered inked imprint of the common alignment marker that was removed in the sixth step; and,
(h) Affixing said layered inked imprint of the design to a card stock.

8. The greeting card of claim 7 wherein the cutting tool is a pair of scissors.
